(19) United States
(12) Patent Application Publication
(10) Pub. No.: US 2011/0099134 A1
(43) Pub. Date: Apr. 28, 2011

(54) Method and System for Agent Based Summarization

(76) Inventors: Sanika Shirwadkar, (US); Sameer Yami, (US)

(21) Appl. No.: 12/913,593

(22) Filed: Oct. 27, 2010

Related U.S. Application Data
(60) Provisional application No. 61/255,846, filed on Oct. 28, 2009.

(51) Int. Cl. G06F 15/18; G06F 17/30

(52) U.S. Cl. 706/12; 707/705; 707/E17.008; 707/E17.014

(57) ABSTRACT

A method and system for using a proxy agent based access to documents and the corresponding summaries and its subsequent usage is disclosed. The method and system provides for retrieving a document, generating or retrieving summary, generating statistical parameters to judge the summary quality, using text segmentation to judge the quality of the summary, getting user rating input and using it to train a classifier, using the classifier to predict the rating of a summary, displaying the summary along with its rating, and optionally overlaying the summary display with relevant advertising and thus prevent denial of information/information overload and stimulating accelerated learning.

### CROSS-REFERENCE TO RELATED APPLICATIONS

This application claims the benefit of PPA Ser. No. 61/255,846, filed on Oct. 28, 2009 by one of the present inventors—Sanika Shirwadkar, which is incorporated by reference.

### TECHNICAL FIELD

The present invention relates generally to computer software systems. In particular, an embodiment of the invention relates to a method and system for browsing the world wide web (Internet) or a local/remote file system using a proxy agent that also generates summaries of documents for quicker information dispersal and for faster learning of educational material.

### BACKGROUND ART

Electronic data (documents containing text, and textual captions/tags parts of audio/video/images etc.) usually contains ‘meta-data’, i.e. data describing data, generated to help readers understand what is described in the document. This meta-data, is generated using the title of the document, the keywords that are used in the document, or using some of the sub-titles/headings of the document. This meta-data can then be embedded in the document as its property (for example, Microsoft Word documents have a property which can store document related information). However, the problem of this approach is that the keywords give an incomplete idea about the document. Even if the user searches documents using a search engine, the number of documents searched is large and as a result the user needs to go through the entire set of documents and then arrive at an understanding of the various documents.

During web browsing/file system browsing, a user is required to go through the various URLs or documents and read through the entire text to understand the document. Many URLS during web browsing are of no use and waste the user's time and resource.

In certain documents for the web (i.e. web pages), search engines derive all the words used in the web documents (i.e. web pages), and index the document based on the words. In this way the words of the document become the meta-data for the document. This meta-data then works as an index for a user, who wants to understand the document without going over the details of the document. In this case, the web search engine may index the document based on certain keywords that do not have much relevance in terms of the context of the document. For example, a page may be dedicated to Shakespeare in general and has not much relevance in terms of the Shakespeare's drama Hamlet. The onus to find the correct web page hence rests on the human reader who must not only provide the correct keywords while searching, but also go through (read and understand) the web pages that are shown by the web engine, in order to find the web page that has the required information. The user then needs to go over the web page(s) and then identify the right page.

Thus these systems do not prevent ‘Denial of Information’ where the human reader is flooded with information in form of hundreds of documents or web pages that may not be relevant, thus resulting in wastage of user, network bandwidth and client/server computing time. This also prevents a user to quickly learn about a subject.

Some of such systems may also be the cause of information overload, where an excessive amount of information is presented to the human reader, upon whom falls the time-consuming task of reading and analyzing all this information in order to discover the needed knowledge or answer.

All these systems lack the ability to provide more detailed document search by taking into account a limited corpus of documents and yet provide a fast, concise, complete and understandable answer based on document content summary that enables a human reader to quickly understand the topic at hand.

Accordingly, a need exists for a method and system which summarizes browsed documents and provides semantically generated comprehensive summaries for a URI that can be used effectively by human readers in quick understanding, thus preventing a ‘Denial of Information’ and loss of computing and network resources, and stimulating accelerated learning.

### SUMMARY OF THE INVENTION

In accordance with the present invention, there is provided a method and system for summarizing input URI or text using agent proxy software that can be used effectively by man or machine readers in quickly understanding the context of the document, thus preventing a ‘Denial of Information’. The invention also improves usage of computing and network resources.

For instance, one embodiment of the present invention provides a method and system for fetching the content of the URI and generating a summary shown next to the actual URI. These summaries are stored along with the document or it's Uniform Resource Identifier, so that they can be retrieved whenever the document is retrieved.

In an embodiment, the summary information is displayed along with a relevant advertisement.

In one embodiment, the summary and the advertisement can be derived by making use of psycholinguistical semantic priming.

In one embodiment, the user browses the Internet through a proxy that fetches the required documents for the user.

In one embodiment, the user browses the file system through an agent proxy that fetches the required documents and their corresponding summaries for the user.

In one embodiment, the user is provided with a tool such as a browser that internally fetches summaries for browsed documents and shows them to the user. In this case, the proxy is internal to the tool and user does not explicitly invoke the proxy.

In another embodiment, the agent is a proxy web-site, a browser, a web plugin, an add-on, a phone application, a software service or any similar component. It is to be noted that these examples are for the purpose of explaining the concept and should not be taken as a limitation on the proposed invention.

In another embodiment, other information such as a tag cloud, predicted rating, entities found in the web page etc. are also shown along with the summary.

In another embodiment, the summaries shown also contain system provided summary rating.

In an embodiment, the automatic summary rating is obtained by using the generated summary and comparing it with the original document and then using a trained classifier to predict the summary rating.

In another embodiment, the classifier is trained on ratings of previously generated summaries.

In another embodiment, the classifier is trained by comparing the difference of means, standard deviation, divergence etc. of the original documents and the corresponding summaries.

In one embodiment, the summary parameters are maintained in a cache that allows for faster access.

In another embodiment, the summaries are cached on a need basis and made available based on user request.

In another embodiment, user can also rate the summaries.

In an embodiment, the precision and recall of the summaries are calculated using a text segmentation method that organizes the original document based upon concepts and then calculating the number of concepts that are present in the summary.

In an embodiment, the summary of a document is compared with the summary of another but similar document to identify the quality of the summary(s).

In yet another embodiment, the summaries are parsed using Natural Language Processing (NLP) techniques for finding out the possible grammatical parts of the sentence. These grammatical parts are then used to change sentences that have pronouns in them.

In another embodiment, large documents are processed in parts, with each part shown on user request.

In yet another embodiment, the length of summary can be selected by changing the threshold value, which allows summary from one sentence to multiple sentences.

In yet another embodiment, a summarization icon link is displayed next to each URI on the current web page. User can select this link to view the summary of that specific URI's content.

### BRIEF DESCRIPTION OF THE DRAWINGS

The accompanying drawings, which are incorporated in and form a part of this specification, illustrate embodiments of the invention and, together with the description, serve to explain the principles of the invention.

FIG. 1 is a block diagram illustrating various processing parts used during the generation of a summary for a URI.

FIG. 2 is a flowchart of steps performed during generation of a summary before displaying it to a user.

FIG. 3 is a flowchart of steps performed for calculating the summary quality.

FIG. 4 is a block diagram of an embodiment of an exemplary computer system used in accordance with one embodiment of the present invention.

### DETAILED DESCRIPTION OF THE INVENTION

Reference will now be made in detail to the preferred embodiments of the invention, examples of which are illustrated in the accompanying drawings. While the invention will be described in conjunction with the preferred embodiments, it will be understood that they are not intended to limit the invention to these embodiments.

On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well-known methods, procedures, components and circuits have not been described in detail as not to unnecessarily obscure aspects of the present invention.

### Notation and Nomenclature

Some portions of the detailed descriptions, which follow, are presented in terms of procedures, logic blocks, processing and other symbolic representations of operations on data bits within a computer system or electronic computing device. These descriptions and representations are the means used by those skilled in the data processing arts to most effectively convey the substance of their work to others skilled in the art. A procedure, logic block, process, etc., is herein, in generally, conceived to be a self-sequence of steps or instructions leading to a desired result. The steps are those requiring physical manipulations of physical quantities. Usually, though not necessarily, these physical manipulations take the form of electrical or magnetic signals capable of being stored, transferred, combined, compared, and otherwise manipulated in a computer system or similar electronic computing device. For reasons of convenience, and with reference to common usage, these signals are referred to as bits, values, elements, symbols, characters, terms, numbers, or the like with reference to the present invention.

It should be borne in mind, however, that all of these terms are to be interpreted as referencing physical manipulations and quantities and are merely convenient labels and are to be interpreted further in view of terms commonly used in the art. Unless specifically stated otherwise as apparent from the following discussions, it is understood that throughout discussions of the present invention, discussions utilizing terms such as “generating” or “modifying” or “retrieving” or the like refer to the action and processes of a computer system, or similar electronic computing device that manipulates and transforms data. For example, the data is represented as physical (electronic) quantities within the computer system's registers and memories and is transformed into other data similarly represented as physical quantities within the computer system memories or registers or other such information storage, transmission, or display devices.

### Summarization Agent

The method and system of the present invention provide for the usage of a proxy agent to browse/surf the Internet/a file system. According to the exemplary embodiments of the present invention, the system is implemented to suite the requirements of a user who is browsing/searching for documents and does not have the time or the interest to read the entire document before judging that it is suitable for the user's purposes. Thus, according to such embodiments, it is possible to generate a summary when the user visits a web site.

According to one embodiment, the summary is done in real time or fetched from a pre-generated summary database and shown along with the document URI.

In an embodiment, the text below the links in a web page is replaced by or shown along with the corresponding summary.

In an embodiment, a relevant advertisement is shown along with the summary.

In another embodiment, the advertisement and the summary use psycholinguistical semantic priming concepts.

In an embodiment of the invention, the summary is retrieved from a storage and show with the document URI.

In another embodiment, summary is compared with the actual document content statistically using various parameters such as mean of weights, standard deviation, divergence etc.

In another embodiment, the summary parameters are stored in a cache for faster access.

In another embodiment, user ratings are used to train a classifier summary along with the statistical parameters.

According to another embodiment, the classifier is used to predict the rating of the summary.

In an embodiment, the probability distribution of the original document's parameters is compared to the probability distribution of the summary's parameters to predict the the probable rating of the summary by the user.

In another embodiment, if the rating of a summary is low then the proxy shows the summary with a warning.

In another embodiment, NLP is used on generated summaries to find out the part of speech structures which are then used to replace pronouns.

According to another embodiment, the summary is stored in the database along with the Uniform Resource Identifier (URI) of the document. This database can then be used to display summaries of document.

According to another embodiment, the agent can be a proxy website, a browser plugin, browser add-on, a phone application, a web service or any other software component.

In another embodiment, the summary can be done in real time or can be fetched from a server.

In an embodiment, various summaries of links that are related or are a result of a search can be combined to give a composite summary.

In an embodiment, the composite summary specifically chooses summaries to suit the search query term.

In an embodiment, summaries can be embedded as part of the original page itself.

In an embodiment, summaries of search results are combined to form a single document.

In an embodiment, all the summaries of links in a web page are pre-fetched from a cached storage.

### Exemplary System in Accordance with Embodiments of the Present Invention

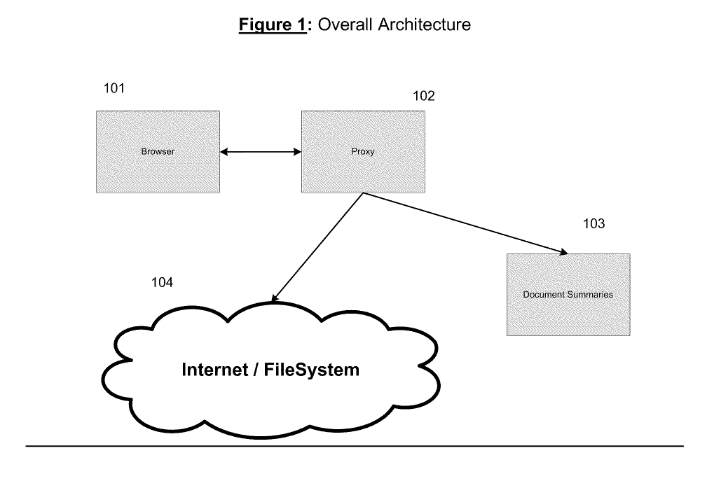

FIG. 1 represents a proxy based summary generation system according to one embodiment of the present invention. Referring to FIG. 1, there is shown a Web browser 101 that allows a user to browse documents, a proxy server 102, a document summary database 103, and the Internet 104.

According to one embodiment, the browser 101 always accesses the Internet 104 in parallel with the document summaries 103 via the proxy server 102.

According to one embodiment, the proxy 102 is an internal part of the browser making the browser a summarization browser.

According to another embodiment, the proxy 102 is an external plugin software or may be an independent software component that acts as a proxy agent.

In another embodiment, the browser 101 is replaceable by another document reader software.

According to another embodiment, the proxy 102 is a web service.

According to one embodiment, the ‘Document summaries’ 103 can be shown as part of proxy 102 or as part of browser 101.

### Exemplary Operations in Accordance with Embodiments of the Present Invention

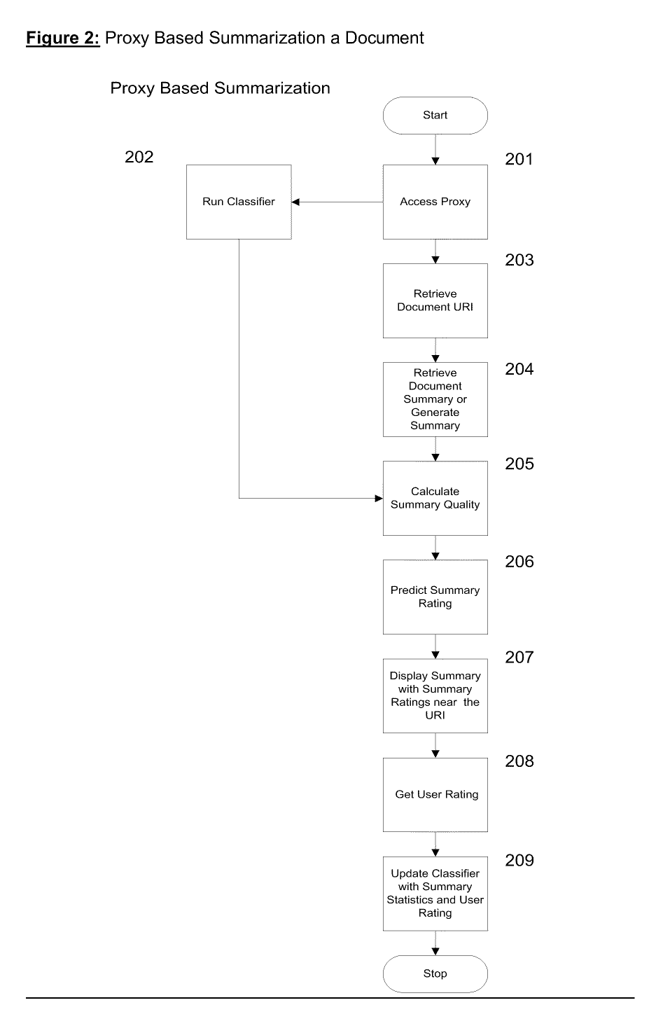

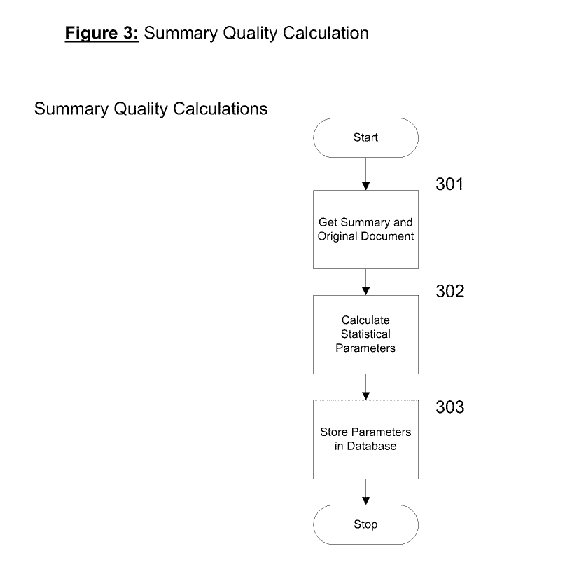

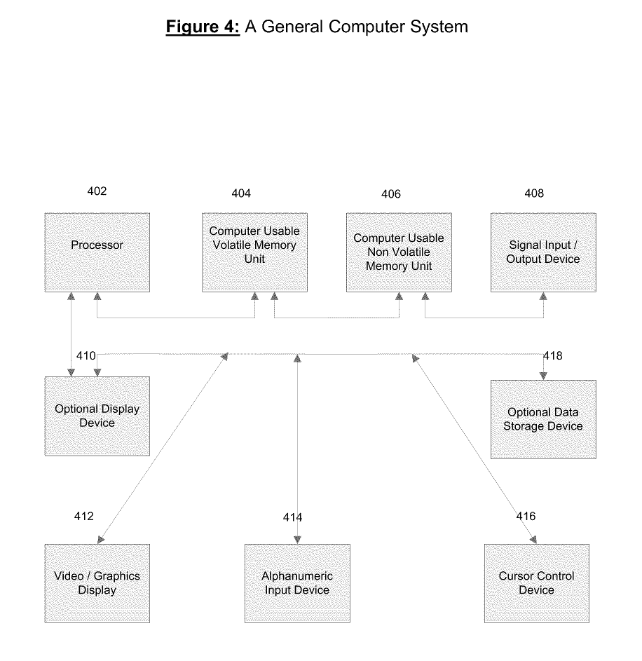

FIGS. 2 to 3 are flowcharts of computer-implemented steps performed in accordance with one embodiment of the present invention for providing a method or a system for proxy based summarization. The flowcharts include processes of the present invention, which, in one embodiment, are carried out by processors and electrical components under the control of computer readable and computer executable instructions. The computer readable and computer executable instructions reside, for example, in data storage features such as computer usable volatile memory (for example: 404 and 406 described herein with reference to FIG. 4). However, computer readable and computer executable instructions may reside in any type of computer readable medium. Although specific steps are disclosed in the flowcharts, such steps are exemplary. That is, the present invention is well suited to performing various steps or variations of the steps recited in FIGS. 2 to 3. Within the present embodiment, it should be appreciated that the steps of the flowcharts may be performed by software, by hardware or by any combination of software and hardware.

### Agent Proxy Based Access to Summarization Data

FIG. 2 consists of the steps performed by the proxy engine in order to allow access to a document summary.

In step 201, the proxy agent is accessed by the user to browser a document. In step 202, a classifier is started. The document URI is retrieved in 203. In step 204, the document summary is generated in real time or retrieved from a server. In step 205, the classifier is used to calculate the quality of the summary and in step 206, the rating of the summary is predicted. In step 207, the summary and ratings are displayed to the user. In step 208, the summary rating input is taken from the user and the classifier is updated with this input for better accuracy in step 209.

### Calculation of Summary Quality

FIG. 3 consists of the steps performed by the summary engine to calculate the quality of the summaries. In step 301, both the summary and the original document are retrieved. In step 302, various statistical parameters such as mean, standard deviation, precision and recall based on text segmentation and various divergences are calculated which in turn are used to predict the summary quality. All these parameters and the predicted summary are stored in the database in step 303.

### Exemplary Hardware in Accordance with Embodiments of the Present Invention

FIG. 4 is a block diagram of an embodiment of an exemplary computer system 400 used in accordance with the present invention. It should be appreciated that the system 400 is not strictly limited to be a computer system. As such, system 400 of the present embodiment is well suited to be any type of computing device (for example: server computer, portable computing device, mobile device, embedded computer system, etc.). Within the following discussions of the present invention, certain processes and steps are discussed that are realized, in one embodiment, as a series of instructions (for example: software program) that reside within computer readable memory units of computer system 400 and executed by a processor(s) of system 400. When executed, the instructions cause computer 400 to perform specific actions and exhibit specific behavior that is described in detail below.

Computer system 400 of FIG. 4 comprises an address/data bus 410 for communicating information, one or more central processors 402 couples with bus 410 for processing information and instructions. Central processing unit 402 may be a microprocessor or any other type of processor. The computer 400 also includes data storage features such as a computer usable volatile memory unit 404 (for example: random access memory, static RAM, dynamic RAM, etc.) coupled with bus 402, a computer usable non-volatile memory unit 406 (for example: read only memory, programmable ROM, EEPROM, etc.) coupled with bus 410 for storing static information and instructions for processor(s) 402. System 400 also includes one or more signal generating and receiving devices 408 coupled with bus 410 for enabling system 400 to interface with other electronic devices. The communication interface(s) 408 of the present embodiment may include wired and/or wireless communication technology. For example, in one embodiment of the present invention, the communication interface 408 is a serial communication port, but could also alternatively be any of a number of well known communication standards and protocols, for example: Universal Serial Bus (USB), Ethernet, FireWire (IEEE 1394), parallel, small computer system interface (SCS), infrared (IR) communication, Bluetooth wireless communication, broadband, and the like.

Optionally, computer system 400 can include an alphanumeric input device 414 including alphanumeric and function keys coupled to the bus 410 for communicating information and command selections to the central processor(s) 402. The computer 400 can include an optional cursor control or cursor-directing device 416 coupled to the bus 410 for communicating user input information and command selections to the central processor(s) 402. The system 400 can also include a computer usable mass data storage device 418 such as a magnetic or optional disk and disk drive (for example: hard drive or floppy diskette) coupled with bus 410 for storing information and instructions. An optional display device 412 is coupled to bus 410 of system 400 for displaying video and/or graphics.

As noted above with reference to exemplary embodiments thereof, the present invention provides a method and system for agent based summarization. The method and system provides for accessing a document along with its summary, calculating a summary quality based on the original document, and its usage in training a classifier and thus providing a better summary that in turn prevents denial of information/information overload and accelerates learning of concepts.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of invention and its practical application, to thereby enable others skilled in the art to best utilize the invention and various embodiments with various modifications as are suited to the particular use contemplated. It is intended that the scope of the invention to be defined by the claims appended hereto and their equivalents.

What is claimed is:

1. A method comprising:
Generating or accessing pre-generated document summary using an intermediary agent component,
whereby said summary prevents information overload when plurality of electronic data is available.

2. The method of claim 1, wherein the said summary comprises of the most informative sentences of the document and wherein the generation of said summary further comprises: comparing with the original document and calculating statistical parameters; storing parameters in a cache and training a classifier with the statistical parameters to predict the summary rating.

3. The method of claim 1, wherein the said summary is displayed along with other useful features not limited to a predicted rating, an option for further input of user rating, and a relevant advertisement.

4. The method of claim 1, wherein the said summary uses semantic priming to accelerate user learning.

5. The method of claim 1, wherein the summary is used for processing by a natural language processing system for appropriate substitution of various part of speech tags.

6. The method of claim 1, wherein the said summary's parameters and the said summary's probability distribution is compared with the original document's parameters and probability distribution.

7. The method of claim 1, wherein the precision and recall of the summary is calculated based on the concepts present in the original document.

8. A system comprising:
Means adapted for generating or accessing pre-generated document summary using an intermediary agent component,
whereby said summary prevents information overload when plurality of electronic data is available.

9. The system of claim 8, wherein the said summary comprises of the most informative sentences of the document and wherein the generation of said summary further comprises: comparing with the original document and calculating statistical parameters; storing parameters in a cache and training a classifier with the statistical parameters to predict the summary rating.

10. The system of claim 8, wherein the said summary is displayed along with other useful features not limited to: a predicted rating, an option for further input of user rating; and a relevant advertisement.

11. The method of claim 8, wherein the said summary uses semantic priming to accelerate user learning.

12. The system of claim 8, wherein the summary is used for processing by a natural language processing system for appropriate substitution of various part of speech tags.

13. The system of claim 8, wherein the said summary's parameters and the said summary's probability distribution is compared with the original document's parameters and probability distribution.

14. The system of claim 8, wherein the precision and recall of the summary is calculated based on the concepts present in the original document.

15. A non-transitory computer readable medium of instructions comprising:
instructions for generating or accessing pre-generated document summary using an intermediary agent component,
whereby said summary prevents information overload when plurality of electronic data is available.

16. The non-transitory computer readable medium of instructions of claim 15, wherein the said summary comprises of the most informative sentences of the document and wherein the generation of said summary further comprises: comparing with the original document and calculating statistical parameters; storing parameters in a cache and training a classifier with the statistical parameters to predict the summary rating.

17. The non-transitory computer readable medium of instructions of claim 15, wherein the said summary is displayed along with other useful features not limited to: a predicted rating, an option for further input of user rating; and a relevant advertisement.

18. The non-transitory computer readable medium of instructions of claim 15, wherein the said summary uses semantic priming to accelerate user learning.

19. The non-transitory computer readable medium of instructions of claim 15, wherein the summary is used for processing by a natural language processing system for appropriate substitution of various part of speech tags.

20. The non-transitory computer readable medium of instructions of claim 15, wherein the said summary's parameters and the said summary's probability distribution is compared with the original document's parameters and probability distribution.

21. The non-transitory computer readable medium of instructions of claim 15, wherein the precision and recall of the summary is calculated based on the concepts present in the original document.
